(19) United States
(12) Patent Application Publication
(10) Pub. No.: US 2016/0344984 A1
(43) Pub. Date: Nov. 24, 2016

(54) ATHLETE CAMERA

(71) Applicant: Robert E. Fitzgerald, North Barrington, IL (US)

(72) Inventor: Robert E. Fitzgerald, North Barrington, IL (US)

(21) Appl. No.: 15/159,553

(22) Filed: May 19, 2016

Related U.S. Application Data
(60) Provisional application No. 62/163,487, filed on May 19, 2015.

(51) Int. Cl. H04N 7/18; H04N 5/225

(52) U.S. Cl. CPC H04N 7/185; H04N 5/2253; H04N 5/2254; H04N 5/63

(57) ABSTRACT

A headgear mounted camera including image processing and wireless communications modules to facilitate wireless data communications of video and audio to remote clients including smartphones and tablet computers, wherein the head mounted camera is mounted in at least one of: a sweatband, helmet, goggles, hat, and glasses. A camera that may be built into, mounted and or attachable/detachable as a camera lens to a verity of different headgear products and can transmits video data to computers, including portable handheld devices such as smartphones/and tablets computers.

### INVENTION PRIORITY

The present application is a continuation of U.S. Provisional Application Ser. No. 62/163,487, filed May 19, 2015, entitled “Athlete Camera,” which is incorporated herein in its entirety for its teaching.

### TECHNICAL FIELD

The embodiments are related to wearable headwear/headgear including wired and wireless communication abilities with handheld portable computing devices, including smartphone, tablets, encoders and computers. More particularly, the embodiments relate to a camera that may be built into, mounted and or attachable/detachable as a camera lens to a verity of different headgear products and can transmits video data to computers, including portable handheld devices such as smartphones/and tablets computers.

### BACKGROUND OF THE EMBODIMENTS

There is need for additional choice of camera viewing options that can be used with smartphones/tablets instead of only using the existing camera built into the device. The Smartphones/tablets all have built-in cameras (front and rear view camera) and when a person wishes to take video using these devices they must hold the device with their hands.

### SUMMARY OF THE EMBODIMENTS

There is therefore a need to have external camera lens choices that can be added to the current camera choices view, and that can operate as “hands-free” cameras.

It is a feature of the embodiment to provide external camera views from small cameras embedded in headgear worn by users (e.g., athletes) during activities and to provide video from the headgear mounted cameras to computers.

It is also a feature of the embodiments that video from headgear mounted cameras can be delivered wirelessly to computers over short-range data connections (e.g., Bluetooth) or via wireless data communications networks (e.g., Wifi).

It is another feature that computer receiving video data from headgear mounted cameras can be provided in the form of handheld computers, including smartphones, tablet computers, and laptops.

It is also a feature of the embodiments to provided choices of camera views to computer users.

It is also a feature of the embodiments that the headgear mounted, cameras can be operated as “hands-free” cameras.

### BRIEF DESCRIPTION OF THE DRAWINGS

FIG. 1 illustrates a baseball cap with an integrated headgear camera and optional connectivity to a processing unit.

FIG. 2 illustrates eyeglasses with an integrated headgear camera, on board communications unit, and optional connectivity to an external processing unit.

FIG. 3 illustrates a baseball helmet with an integrated headgear camera, on board communications unit, and optional connectivity to an external processing unit.

FIG. 4 illustrates a hockey helmet with an integrated headgear camera, on board communications unit, and optional connectivity to an external processing unit.

FIG. 5 illustrates goggles (ski or diving) with an integrated headgear camera, on board communications unit, and optional connectivity to an external processing unit.

FIG. 6 illustrates a service hat (e.g., police officer, etc.) with an integrated headgear camera, on board communications unit, and optional connectivity to an external processing unit.

FIG. 7 illustrates a diving helmet with an integrated headgear camera, on board communications unit, and optional connectivity to an external processing unit.

FIG. 8 illustrates a sweatband with an integrated headgear camera and optional connectivity to an external processing unit.

FIG. 9 illustrates a sweatband with an integrated headgear camera, on board wireless communications, processing unit, and optional connectivity to an external processing unit.

FIG. 10 illustrates a processing unit that can be connected to the headgear camera that is embedded in headgear.

FIG. 11 illustrates a processing unit providing data wirelessly (e.g., Wi-Fi, Bluetooth) to computing devices (e.g., smartphones, desktop computers, tablet computers.

FIG. 12 illustrates scenarios wherein headgear cameras communicate wirelessly to end user devices.

FIG. 13 illustrates scenarios wherein wireless communications for the embodiments can occur over various wireless communications networks, worldwide.

### DETAILED DESCRIPTION OF PREFERRED EMBODIMENTS

that can be fire wired or have a wireless connection using WiFi/Bluetooth to send camera lens data signal to a your smartphone/table with minimal delay in processing, almost instantaneously to smartphone/tablet/computer/encoder. This will provide a smartphone/tablet user a simple camera alternative to the existing camera built into their device and allow them to be able to send images from this external camera that is connected to the headwear/headgear to their smartphone/tablet. These camera lenses may be built-into many headwear components. When the camera lens is using a wireless signal it will require a power source that can be built into the headwear or can be an “attachable/detachable” external power supply to power the wireless camera lens.

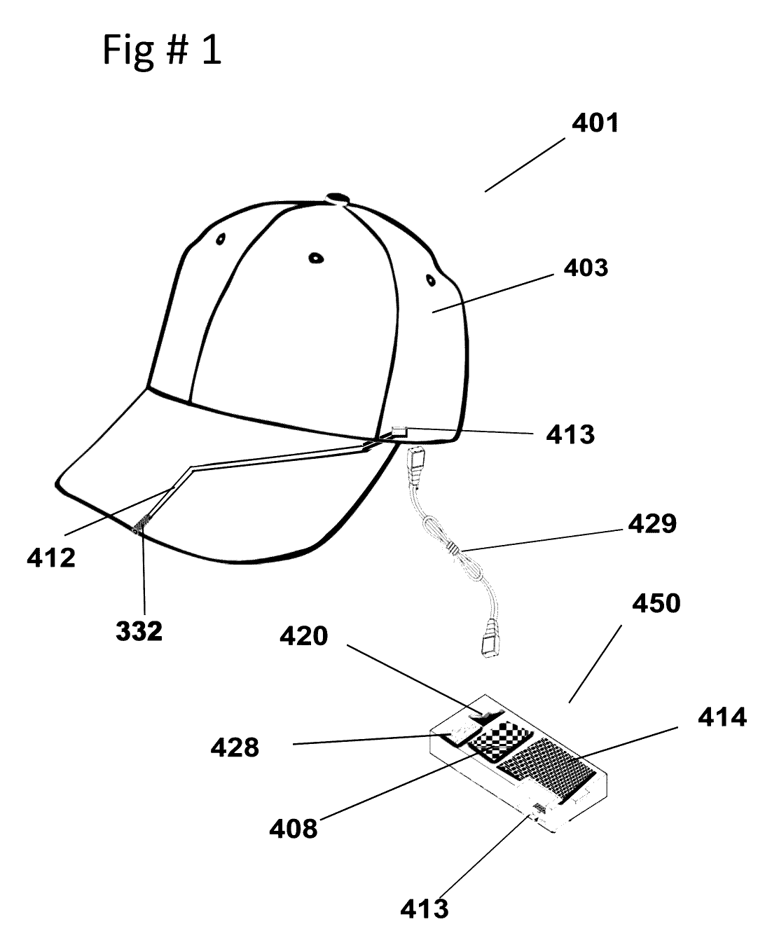

Referring to FIG. 1, illustrated is a baseball cap 401 with an integrated headgear camera 332 with connectivity via wire 412 to other external components, such as a processing unit 450. Connectivity can be achieved via a USB cable 429. The processing unit can include an image processing unit 420, rechargeable battery 414, USB plug 413, a wireless communications module 408 that can support Wi-Fi, Bluetooth and/or cellular data network communications.

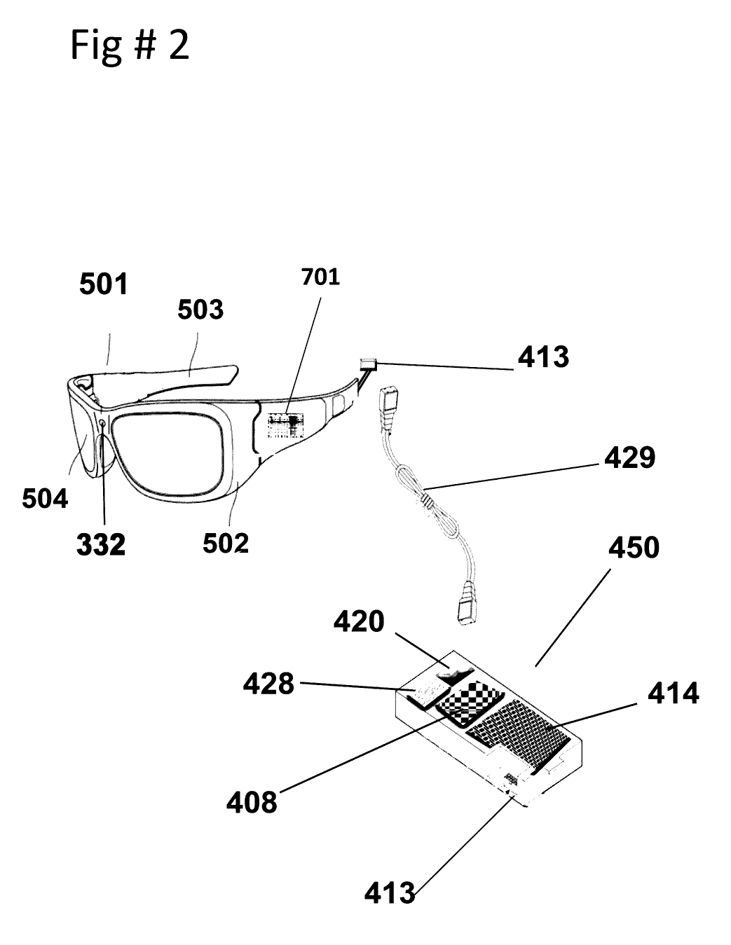

Referring to FIG. 2, illustrated is eyeglasses 501, having lenses 504, an including an integrated headgear camera 332, on board communications unit 701, and optional connectivity via plug 413 and USB able 429 to external processing unit 450.

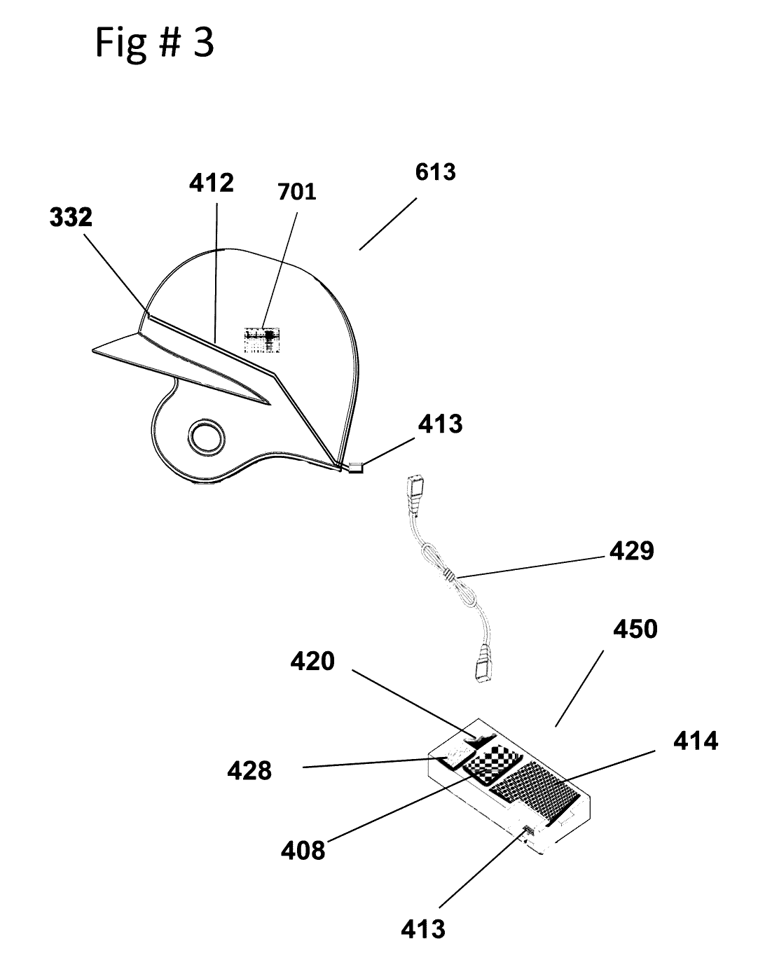

Referring to FIG. 3, illustrated is a baseball helmet 613 with an integrated headgear camera 332, on board communications unit 701, and optional connectivity via wire 412 to an external processing unit 450 via cabling 429.

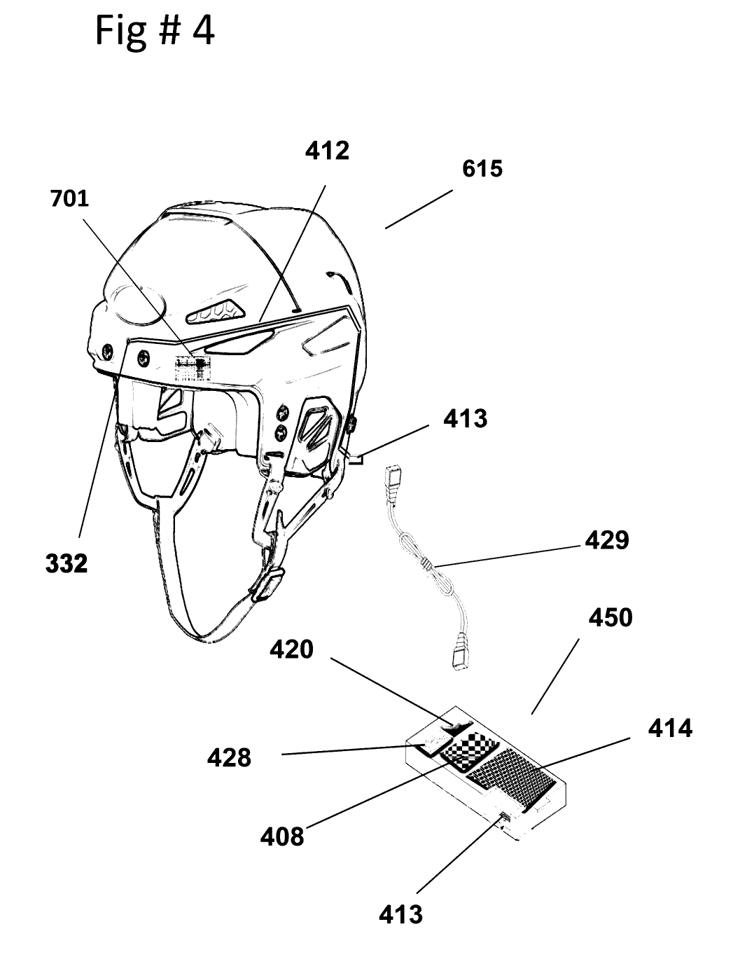

Referring to FIG. 4, illustrated is a hockey helmet 615 with an integrated headgear camera 332, on board communications unit 701, and optional connectivity via wire 412 to an external processing unit 450 via cabling 429.

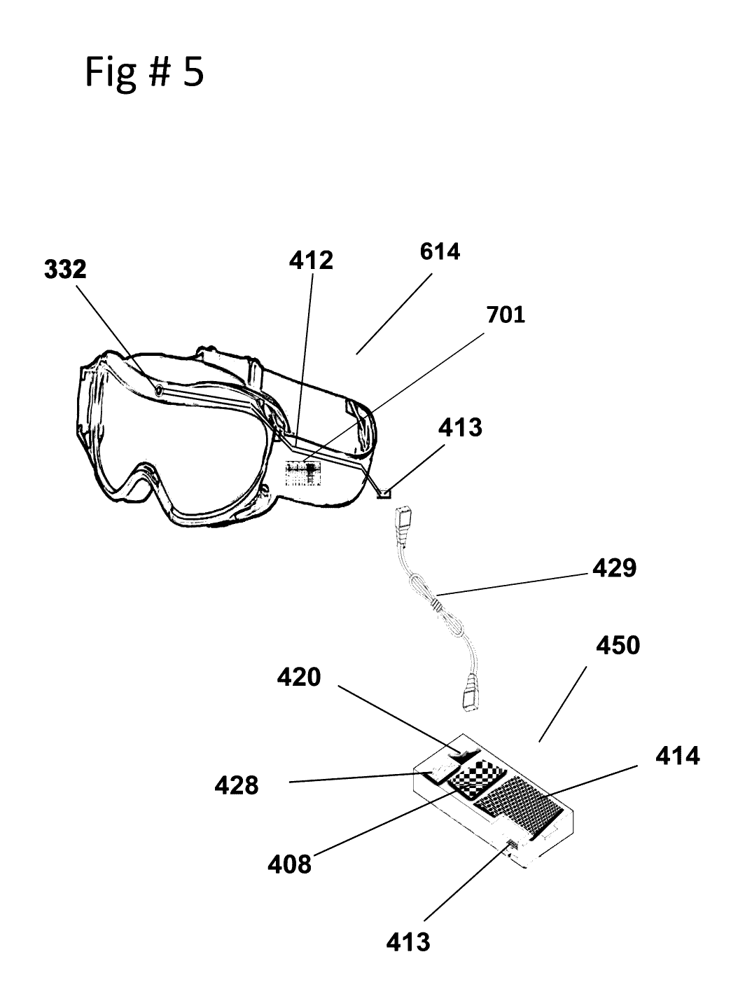

Referring to FIG. 5, illustrated is a goggles (ski or diving) 614 with an integrated headgear camera 332, on board communications unit 701, and optional connectivity via wire 412 to an external processing unit 450 via cabling 429.

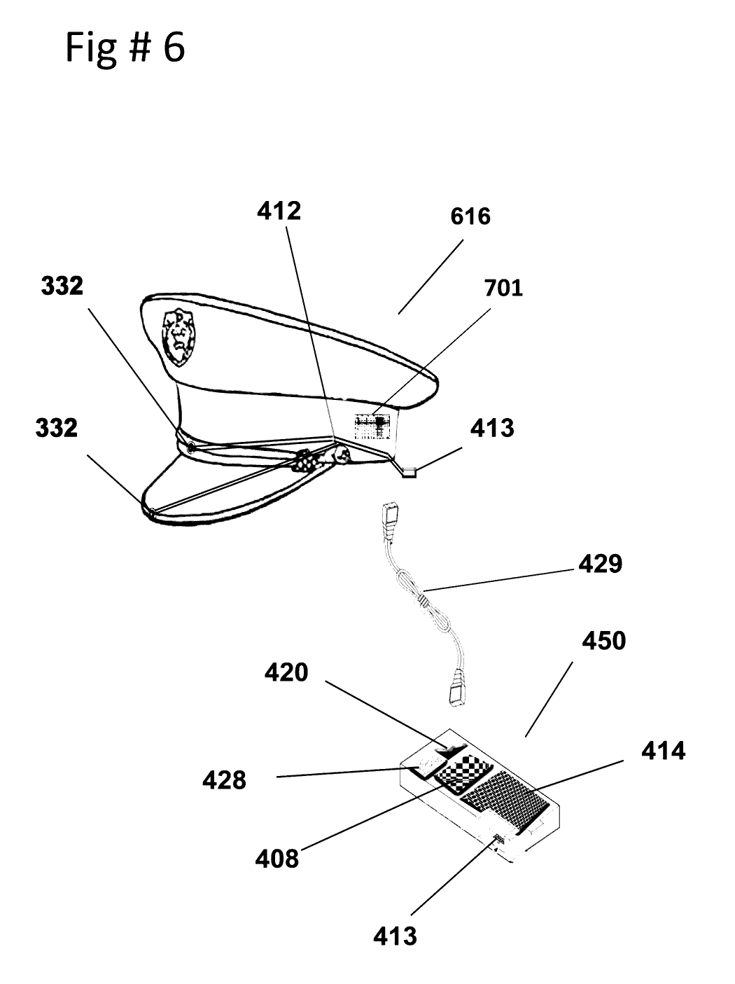

Referring to FIG. 6, illustrated is a service hat (e.g., police officer, etc.) 616 with an integrated headgear camera 332, on board communications unit 701, and optional connectivity via wire 412 to an external processing unit 450 via cabling 429.

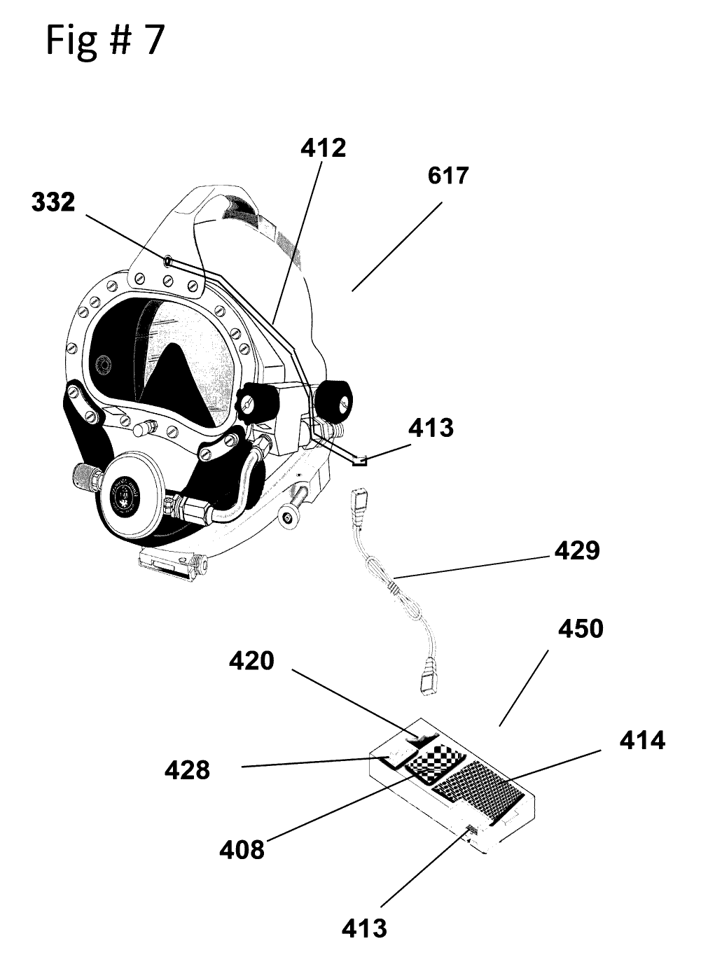

Referring to FIG. 7, illustrated is a diving helmet 617 with an integrated headgear camera 332, on board communications unit 701, and optional connectivity via wire 412 to an external processing unit 450 via cabling 429.

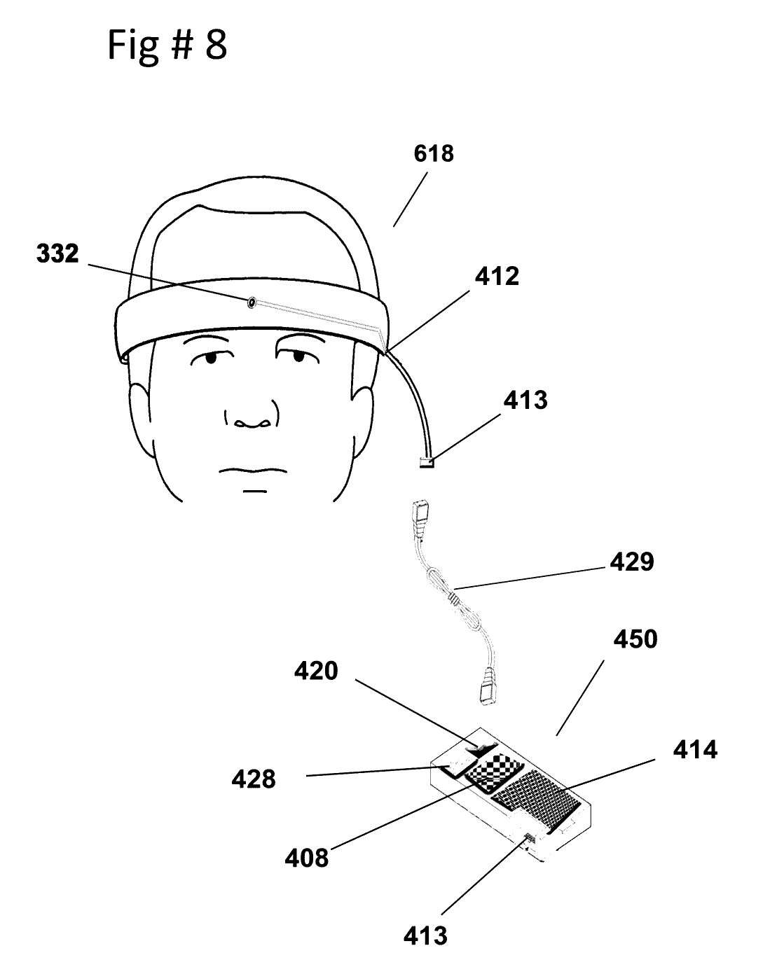

Referring to FIG. 8, illustrated is a sweatband 618 with optional connectivity via wire 412 to an external processing unit 450 via cabling 429.

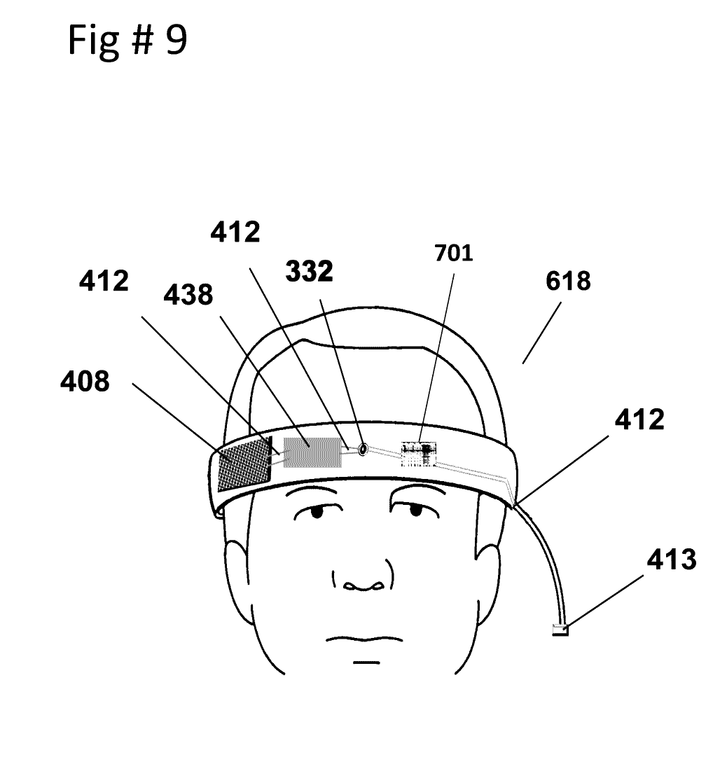

Referring to FIG. 9, illustrated is a sweatband 619 with an integrated headgear camera 332, on board short-range RF communications unit 701, wireless data network communications unit 408, processor 438, and optional connectivity via wire 412 to an external processing unit 450 via cabling 429.

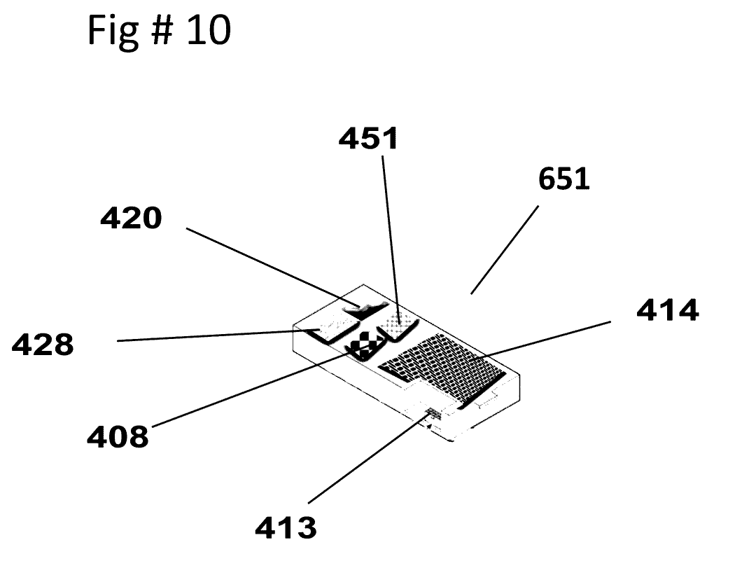

Referring to FIG. 10, illustrated is a processing unit 651 that can be connected to the headgear camera that is embedded in headgear. The processing unit can include an image processing unit 420, rechargeable battery 414, USB plug 413, a wireless communications module 408 that can support Wi-Fi, Bluetooth and/or cellular data network communications, imaging processing unit 420, audio processor 428.

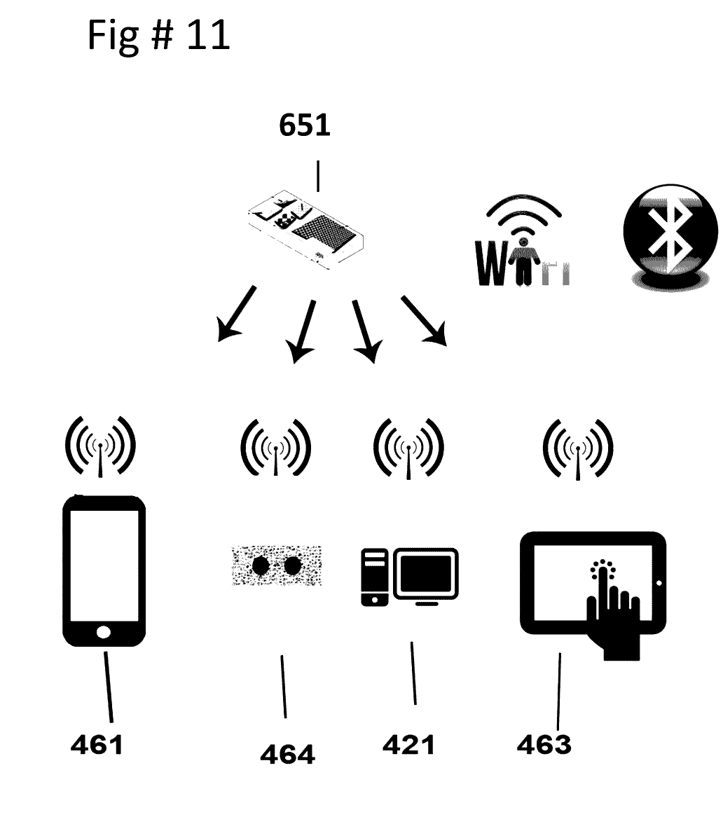

Referring to FIG. 11, illustrated is a processing unit 651 providing data (video and/or audio) obtained from headgear-mounted camera 332 wirelessly (e.g., Wi-Fi, Bluetooth) to computing devices, e.g., smartphones 461, desktop computers 421, tablet computers 463, other image processing components 464.

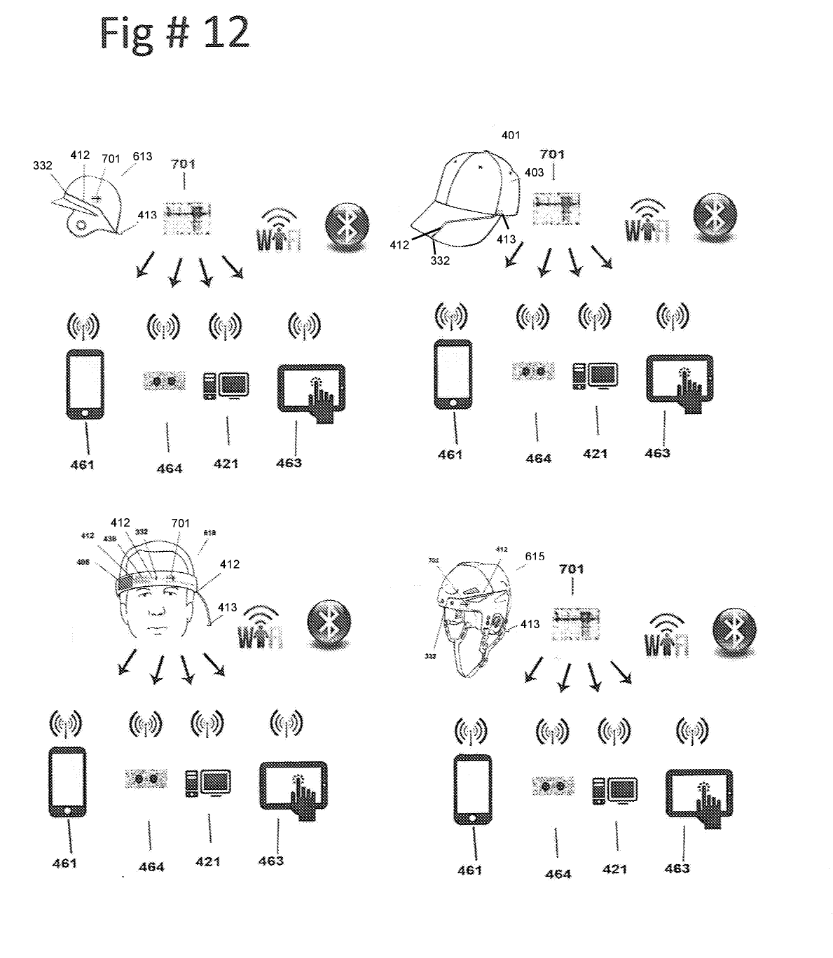

Referring to FIG. 12, illustrated is scenarios wherein headgear cameras 332 can communicate wirelessly to end user devices via wireless communications modules 701.

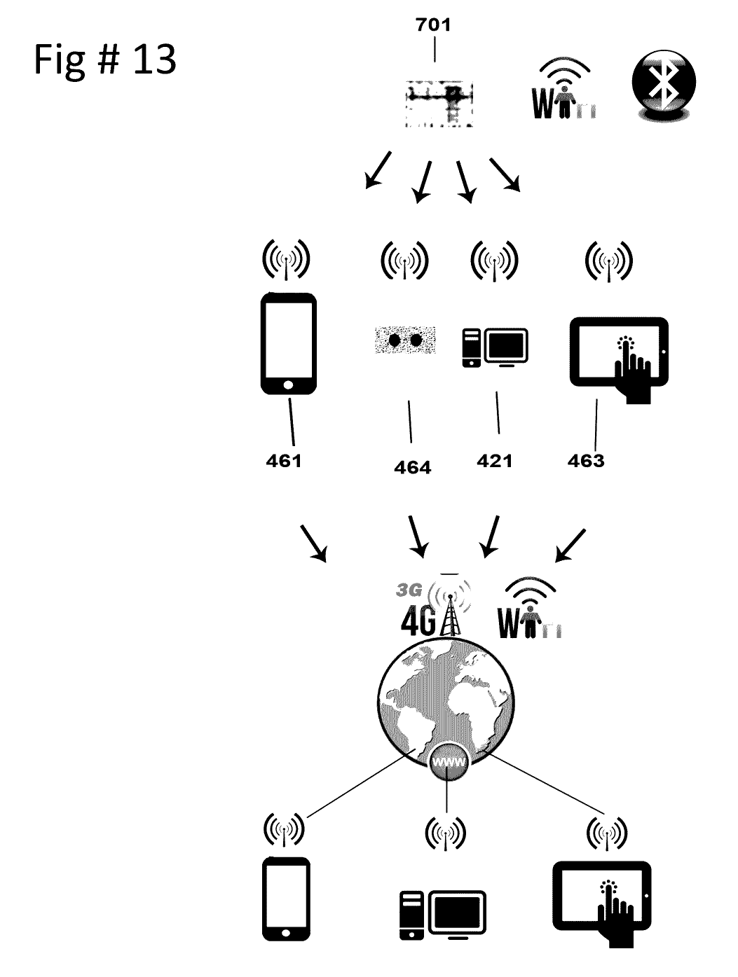

Referring to FIG. 13, illustrated is scenarios wherein wireless communications supported by wireless communications modules 701 can be directly (short range wireless data communications) and over various wireless communications networks to end users, worldwide.

1. A headgear mounted camera including image processing and wireless communications modules to facilitate wireless data communications of video and audio to remote clients including smartphones and tablet computers, wherein the head mounted camera is mounted in at least one of: a sweatband, helmet, goggles, hat, glasses.
